(19) United States
(12) Patent Application Publication
(10) Pub. No.: US 2006/0023147 A1
(43) Pub. Date: Feb. 2, 2006

(54) Laminated retardation plate, polarizing plate with retardation plate, image display and liquid crystal display

(75) Inventors: Kanako Wasai, Osaka (JP); Yasuhisa Toujou, Osaka (JP); Shuuji Yano, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/188,094

(22) Filed: Jul. 25, 2005

(30) Foreign Application Priority Data
Jul. 27, 2004 (JP) 2004-218898

(51) Int. Cl. G02F 1/1335

(52) U.S. Cl. 349/117

(57) ABSTRACT

A laminated retardation plate of the present invention comprises at least two retardation plates made of stretched films of a thermoplastic resin, wherein under the same temperature condition, at least one retardation plate have the relationship of |X1|>|X2|, where X1 represents the dimensional change rate in the direction of slow axis and X2 represents the dimensional change rate in the direction of fast axis; at least one retardation plate have the relationship of |Y1|<|Y2|, where Y1 represents the dimensional change rate in the direction of slow axis and Y2 represents the dimensional change rate in the direction of fast axis; and the each retardation plate are arranged so as to the direction of slow axes thereof are in the same directions. The retardation value variation of the laminated retardation plate is small in the case where the environmental temperature changes.

### BACKGROUND OF THE INVENTION

1. Field of the Invention

The present invention relates to a laminated retardation plate comprising at least two retardation plates made of stretched films of a thermoplastic resin. In addition the invention relates to a polarizing plate with retardation plate containing the laminated retardation plate. Furthermore, the present invention relates to an image display such as a liquid crystal display, an organic electro-luminescent display or a plasma display panel where the laminated retardation plate or the polarizing plate with retardation plate as described above is used.

In addition, the present invention relates to a liquid crystal display where optical members containing a retardation plate made of stretched films of a thermoplastic resin and a polarizing plate are disposed on both sides of a liquid crystal cell.

2. Description of the Related Art

Liquid crystal displays consume little electricity and thin and light-weighted, and therefore, are widely used for display parts of personal computers, television and cellular phones. In particular, screen sizes of televisions have increased and the uniformity of displays has been required for good quality. The uniformity of displays means a display does not have a blur in brightness or a blur in the color or a display does not have a shift in color due to a change in the viewing angle.

In addition, liquid crystal displays are used in a variety of environments. Even room temperature can be assumed to change, for example, ranging from approximately −10° C. to 30° C. due to a change in the season. In addition, when a liquid crystal display is placed in a room of which the temperature is as low as, for example, −10° C., the outside of the liquid crystal display is exposed to the environment of −10° C. while the temperature of the backlight on which the liquid crystal panel makes contact increases up to approximately 40° C. to 50° C. As a result, a difference in the temperature occurs even inside the liquid crystal display. Liquid crystal displays are required to have no change in the brightness or in the color due to such change in the temperature of the environment (The specification of Japanese Patent No. 2945573).

A polarizing plate is used because of means of displaying and in addition a retardation plate is used together with the polarizing plate for the compensation of the viewing angle in a liquid crystal display. In many cases, a polarizing plate and a retardation plate are made to stick to each other with an adhesive. A retardation plate is obtained by stretching, for example, a thermoplastic resin film while adjusting the retardation to a required value in the condition where the thermoplastic film is heated to a temperature not lower than the glass transition temperature.

However, a stretched film obtained according to the above described method is made of a thermoplastic resin, and therefore, the dimensions thereof expand or shrink due to a change in temperature. In addition, the dimensions expand or shrink in an anisotropic manner and in some cases, particularly, expand or shrink to different degrees in the direction of the flow of the stretched film (the direction of the stretched axis) and in the direction perpendicular thereto. Expansion or shrinking of a stretched film due to a change in temperature causes a variation in the retardation value depending on the direction in which such expansion or shrinking occurs.

As described above, a stretched film shrinks or expands due to a change in temperature in reversible manner, and therefore, a change in the retardation value occurs within the plane due to a change in the environment as described above. A variation in the retardation value may cause a blur in brightness of a liquid crystal display. In addition, when the temperature of the liquid crystal display becomes uneven, expansion or shrinking of the stretched film (retardation plate) occurs in a complex manner causing a distortion and a blur in the brightness of the liquid crystal display.

### SUMMARY OF THE INVENTION

An object of the present invention is to provide a retardation plate of which the retardation value has a small variation in the case where the environmental temperature changes. Another object of the invention is to provide a polarizing plate with retardation plate using such said retardation plate. Still another object of the invention is to provide an image display such as a liquid crystal display using such said retardation plate.

Further another object of the present invention is to provide a liquid crystal display where retardation plates are disposed on both sides of a liquid crystal cell and a variation in the retardation plates can be restrained in the case where the environment temperature changes.

The present inventors diligently performed research in order to solve the problem described above, and as a result, found that the above described objects can be achieved using a laminated retardation plate and a liquid crystal display as described below, and thus, the present invention has been completed.

That is, the present invention related to a laminated retardation plate comprising at least two retardation plates made of stretched films of a thermoplastic resin, wherein under the same temperature condition, at least one retardation plate have the relationship of |X1|>|X2|, where X1 represents the dimensional change rate in the direction of slow axis and X2 represents the dimensional change rate in the direction of fast axis;

at least one retardation plate have the relationship of |Y1|<|Y2|, where Y1 represents the dimensional change rate in the direction of slow axis and Y2 represents the dimensional change rate in the direction of fast axis; and

the each retardation plate is arranged so as to the direction of slow axes thereof are in the same directions.

A change in dimensions due to shrinking or expansion occurs to different degrees in the direction of the flow of a stretched film (the direction of the stretched axis: direction of the slow axis) and in the direction perpendicular thereto (the direction of the fast axis) depending on the types of a stretched film and the conditions of stretching that is used as a retardation plate, and therefore, in the above described laminated retardation plate according to the present invention, stretched films of which the dimensional change rate in the direction of the slow axis and the dimensional change rate in the direction of the fast axis are different from each other are combined and thereby the effects of change in the retardation due to expansion or shrinking of the stretched films are reduced in the entire retardation plate.

It is assumed that shrinking (change in dimensions) occurs due to a change in temperature, for example, in a uniaxial stretched film. In the case where the ratios of shrinking in dimensions become |Y1|<|Y2|, the same phenomenon occurs when the stretched film has expanded relatively in the direction of the slow axis from the viewpoint of an optical indicatrix. Namely, front retardation Δnd is considered to increase due to expansion in the direction of the stretched axis. In contrast, in the case where the ratios of shrinking in dimensions become |X1|>|X2|, front retardation Δnd is considered to decrease. According to the present invention, such a stretched film having the relationship of the dimensional change rates of |Y1|<|Y2| and a stretched film (retardation plate) having the opposite relationship of |X1|>|X2| are laminated for use in a manner where the slow axes (stretched axes) of these are parallel and therefore, in the case where a change in temperature occurs, changes in dimensions are counterbalanced both in the direction of the slow axis and in the direction of the fast axis so that a change in the retardation as a whole is restrained.

A variation in the retardation value can be restrained to a small value in such a laminated retardation plate according to the present invention in the case where a change in temperature occurs due to a change in the environment and display properties of an image display can be maintained in such an appropriate manner that a change in color tone is small at the time of application of a voltage.

The dimensional change rate has a value that is measured in accordance with a method that is concretely described in the Examples. The dimensional change rate of a retardation plate (stretched film) has a positive value in the case of expansion and has a negative value in the case of shrinking. The relationships of the dimensional change rate in the direction of the slow axis and the dimensional change rate in the direction of the fast axis that is, |X1|>|X2| and |Y1|<|Y2|, indicate the relationships of the absolute values of the respective dimensional change rates. Here, in the Examples, the dimensional change rates are measured relative to a standard case where the temperature is 25° C.

And the present invention related to a polarizing plate with retardation plate, comprising the above mentioned laminated retardation plate and a polarizing plate.

And the present invention related to an image display, comprising the above mentioned laminated retardation plate or the above mentioned polarizing plate with retardation plate. The above laminated retardation plate and polarizing plate with retardation plate can be applied to image displays such as liquid crystal displays, organic electro-luminescent displays and plasma display panels, and the image displays show excellent display quality where the variation in the retardation due to a change in temperature can be restrained.

As to the image displays, a liquid crystal display is suitable. And a liquid crystal display comprising a liquid crystal cell and an optical member containing a polarizing plate disposed on both sides of the liquid crystal cell, wherein the optical member at least on one side of the liquid crystal cell has the above mentioned polarizing plate with retardation plate, is preferable.

In the liquid crystal display, the slow axes of the retardation plates of said polarizing plate with retardation plate are preferably disposed so as to be parallel to or perpendicular to the longitudinal direction of the liquid crystal display. As described above, it is appropriate to dispose a polarizing plate with retardation plate in order to restrain the variation in the retardation due to a change in temperature and to increase the display quality of the liquid crystal display.

Further, the present invention related to a liquid crystal display comprising a liquid crystal cell and an optical member containing a retardation plate made of stretched films of a thermoplastic resin and a polarizing plate disposed on both sides of the liquid crystal cell, wherein

under the same temperature conditions,

at least one retardation plate in the optical member disposed on one side have the relationship of |X1|>|X2|, where X1 represents the dimensional change rate in the direction of slow axis and X2 represents the dimensional change rate in the direction of fast axis;

at least one retardation plate in the optical member disposed on the other side have the relationship of |Y1|<|Y2|, where Y1 represents the dimensional change rate in the direction of slow axis and Y2 represents the dimensional change rate in the direction of fast axis; and

the optical members disposed on both sides of the liquid crystal cell are arranged so as to the direction of slow axes of the each retardation plate in said optical members is in the same directions.

At least one retardation plate of which the dimensional change rate has the relationship of |X1|>|X2| and at least one retardation plate of which the dimensional change rate has the relationship of |Y1|<|Y2| are used on both sides of the liquid crystal cell and thereby variation in the retardation can be restrained in the retardation plate as a whole.

In the liquid crystal display, the slow axes of the retardation plates of said retardation plate are preferably disposed so as to be parallel to or perpendicular to the longitudinal direction of the liquid crystal display.

### BRIEF DESCRIPTION OF THE DRAWINGS

FIG. 1 is a cross sectional diagram showing an example of a laminated retardation plate according to the present invention;

FIG. 2 is a cross sectional diagram showing an example of a polarizing plate with retardation plate according to the present invention;

FIG. 3 is a cross sectional diagram showing an example of a liquid crystal display according to the present invention;

FIG. 4 is a cross sectional diagram showing another example of a liquid crystal display according to the present invention;

FIG. 5 is a graph showing the relationship between the temperature and the change in the front retardation value Δnd of the laminated retardation plates obtained in Comparison Example 1;

FIG. 6 is a graph showing the relationship between the temperature and the change in the front retardation value Δnd of the laminated retardation plates obtained in Comparison Example 2;

FIG. 7 is a graph showing the relationship between the temperature and the change in the front retardation value Δnd of the laminated retardation plates obtained in Example 1; and

FIG. 8 is a graph showing the relationship between the temperature and the change in the front retardation value Δnd of the laminated retardation plates obtained in Example 2.

### DESCRIPTION OF THE PREFERRED EMBODIMENTS

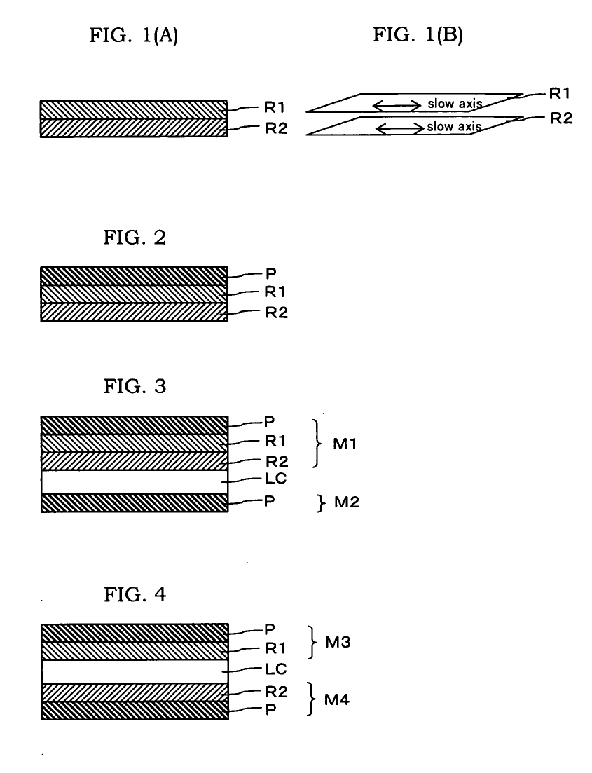

In the following, the present invention is described in reference to the drawings. FIG. 1(A) shows an example of a cross-sectional diagram of a laminated retardation plate according to the present invention where one retardation plate (R1) of which the dimensional change rate has the relationship of |X1|>|X2| and one retardation plate (R2) of which the dimensional change rate has the relationship of |Y1|<|Y2| are laminated. In FIG. 1, though there is one retardation plate (R1) and one retardation plate (R2), a number of each type of retardation plate can be laminated. FIG. 1(B) is a conceptual diagram showing that the slow axes of retardation plate (R1) and retardation plate (R2) are in the same direction.

FIG. 2 is a cross-sectional diagram of an example of a polarizing plate with retardation plate where a polarizing plate (P) is laminated on the laminated retardation plate of FIG. 1. In FIG. 2, though polarizing plate (P) is laminated on the retardation plate (R1) side, polarizing plate (P) may be laminated on either side.

FIG. 3 is a cross-sectional diagram showing a liquid crystal display in the case where the polarizing plate with retardation plate of FIG. 2 is disposed as an optical member (M1) on one side of a liquid crystal cell LC and a polarizing plate (P) is disposed as an optical member (M2) on the other side. Optical members (M1 and M2) may have other optical layers. In FIG. 3, the retardation plate is on the liquid crystal cell (LC) side in the polarizing plate with retardation plate.

FIG. 4 is a cross-sectional diagram showing a liquid crystal display in the case where a retardation plate (R1) and a polarizing plate (P) are disposed as an optical member (M3) on one side of a liquid crystal cell LC and a retardation plate (R1) and a polarizing plate (P) are disposed as an optical member (M4) on the other side. Optical members (M3 and M4) may have other optical layers. In FIG. 4, retardation plate (R1 or R2) is on the liquid crystal cell (LC) side on either side.

Still, though FIGS. 3 and 4 do not illustrate which side is the visual side or the backlight side, either side may be the visual side or the backlight side.

Retardation plate (R1) of which the dimensional change rate has the relationship of |X1|>|X2| and retardation plate (R2) of which the dimensional change rate has the relationship of |Y1|<|Y2| are obtained by appropriately controlling the stretching conditions at the time where a stretched film of a thermoplastic resin is fabricated.

As to the thermoplastic resin, for example, polystyrene, polycarbonate, polyolefins such as polypropylene, polyesters such as polyethylene terephthalate and polyethylene naphthalate, polyvinyl alcohol, polyvinyl butyral; polymethyl vinyl ether, polyhydroxy ethyl acrylate, hydroxy ethyl cellulose, hydroxy propyl cellulose, methyl cellulose, polyallylate, polysulfone, polyether sulfone, polyphenylene sulfide, polyphenylene oxide, polyallyl sulfone, polyvinyl alcohol, polyamide, polyimide, polyvinyl chloride, cellulose based polymers, norbornene based resins and a variety of polymers of two three or more of these, grafted co-polymers and a mixture of these, can be cited.

From among these, polycarbonate is appropriate as a thermoplastic resin that is used for retardation plate (R1) of which the dimensional change rate has the relationship of |X1|>|X2|.

Norbornene based resins are appropriate as a thermoplastic resin that is used for retardation plate (R2) of which the dimensional change rate has the relationship of |Y1|<|Y2|.

As the norbornene based resins, for example, a ring opening polymer or copolymer obtained by polymerizing a norbornene-based monomer, and these polymers of which the properties have been modified by adding maleic acid, or cyclopentadiene, and these to which is hydrogenated; addition polymers of norbornene based monomers; addition copolymers of norbornene based monomers and olefin based monomers such as ethylene or a-olefin, can be cited. Conventional methods can be used for the method for polymerization and the method for hydrogenation.

As to the norbornene based monomers, for example, norbornene and alkyl and/or alkylidene substitutes thereof, such as 5-methyl-2-norbornene, 5-dimethyl-2-norbornene, 5-ethyl-2-norbornene, 5-butyl-2-norbornene, 5-ethylidene-2-norbornene; monomers substituting a portion thereof with a polar group, such as halogen; dicyclopentadiene, 2,3-dihydro dicyclopentadiene; dimethanooctahydronaphthalene, an alkyl and/or alkylidene substitute thereof, and a polar group, such as halogen substitutes, such as
6-methyl-1,4:5,8-dimethano-1,4,4a,5,6,7,8,8a-octahydronaphthalene,
6-ethyl-1,4:5,8-dimethano-1,4,4a,5,6,7,8,8a-octahydronaphthalene,
6-ethylidene-1,4:5,8-dimethano-1,4,4a,5,6,7,8,8a-octahydronaphthalene,
6-chloro-1,4:5,8-dimethano-1,4,4a,5,6,7,8,8a-octahydronaphthalene,
6-cyano-1,4:5,8-dimethano-1,4,4a,5,6,7,8,8a-octahydronaphthalene,
6-pyridyl-1,4:5,8-dimethano-1,4,4a,5,6,7,8,8a-octahydronaphthalene,
6-methoxycarbonyl-1,4:5,8-dimethano-1,4,4a,5,6,7,8,8a-octahydronaphthalene; addition polymers of cyclopentadiene and
tetrahydroindene; trimers and tetramers of cyclopentadiene, such as 4,9:5,8-dimethano-3a,4,4a,5,8,8a,9,9a-octahydro-1H-benzoindene, 4,11:5,10:6,9-trimethano-3a,4,4a,5,5a,6,9,9a,10,10a,11,11a-dodecahydro-1H-cyclopentaanthracene, can be cited.

In addition, other cycloolefins which have one reactive double bond and which make open ring polymerization possible such as cyclopentene, cyclooctene, and 5,6-dihydrodicyclopentadiene can be used together with the norbornene based resins.

ZEONEX and ZEONOR, manufactured by Nippon Zeon Co., Ltd., ARTON, manufactured by JSR Corporation, Topas, manufactured by Ticona Co., and the like, can be cited as concrete examples of the norbornene based resins.

Retardation plate (R1) and retardation plate (R2) can be obtained by stretching the thermoplastic resin film. As for the stretching method, a method for uniaxially stretching in the direction of flow (direction of the slow axis), a method for biaxially stretching in the direction of the slow axis and in addition in the direction perpendicular to this (direction of the fast axis) can be cited. If necessary, the film maybe uniaxially or biaxially stretched in the plane and in addition, the refractive index in the direction of the thickness may be controlled in accordance with a method for stretching in the direction of the thickness. In addition, they may be obtained by tilt alignment according to a method where a stretching process and/or a shrinking process is carried out on a thermoplastic resin film by using the contractile force of a thermal shrinking film which is made to adhere to the thermoplastic resin film and to which heat is applied. The ratio of stretching and the thickness of the film are not particularly limited and the obtained stretched film can be appropriately adjusted by front retardation Δnd that is required. Usually, the ratio of stretching is 1.01 to 3 and it is preferably 1.1 to 2.

In the case where retardation plate (R1) and retardation plate (R2) are laminated so as to be used as a laminated retardation plate as shown in FIGS. 1 to 3, retardation plate (R1) and retardation plate (R2) are laminated in such a manner that the respective slow axes are in the same direction. The entire retardation value of the laminated retardation plate is appropriately set to a desired value (for example, half or quarter wavelength plate). On the other hand, in the case where retardation plate (R1) and retardation plate (R2) are disposed on both sides of a liquid crystal cell, as shown in FIG. 4, retardation plates having desired retardations are used on the respective sides.

Namely, the above described retardation plates may have appropriate retardations in accordance with the purpose of use such as coloring or compensation for the viewing angle caused by, for example, birefringence of a variety of wavelength plates and liquid crystal layers and may be plates where two or more types of retardation plates are laminated so as to control the optical properties such as retardation. Still, alignment films of a liquid crystal polymer, alignment layers of a liquid crystal polymer that are supported by films and the like can be cited as the retardation plates, and they can be used in the above described combination retardation plate (R1) and retardation plate (R2).

A polarizing plate with retardation plate that is obtained by combining a laminated retardation plate or a retardation plate as described above with a polarizing plate is used as an elliptical polarizing plate or a circular polarizing plate. An elliptical polarizing plate is effectively used in the case of white or black viewing which does not have coloring where such coloring (blue or yellow) that is caused by the birefringence of the liquid crystal layer of a super twisted nematic(STN) type liquid crystal display is compensated(prevented). Furthermore, it is preferable to control the three-dimensional refractive index so that coloring that may be caused when the screen of the liquid crystal display is viewed in a diagonal direction can be compensated (prevented). A circular polarizing plate is effectively used in the case where, for example, a color tone of the image of a reflection-type liquid crystal display of which the image is displayed with color is adjusted and has a function of reflection prevention.

Though a polarizer itself can be used as the polarizing plate, a polarizer which has a transparent protective film on one or both sides is generally used.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type orientation films, such as dehydrated polyvinyl alcohol and dehydrochlorinated polyvinyl chloride, etc. may be mentioned. In these, a polyvinyl alcohol type film on which dichromatic materials (iodine, dyes) is absorbed and oriented after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

The transparent protective film is prepared as a polymer coating layer or a film laminate layer. As the transparent polymer or film materials forming the transparent protective, suitable transparent material is used, among them excellent in transparency, mechanical strength, heat stability, water shielding property, isotropy, etc. may be preferably used. As materials of the above-mentioned transparent protective film, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming the transparent protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned. The transparent protective film was made of a cured layer with heat curing type or ultraviolet ray curing type resins, such as acryl based, urethane based, acryl urethane based, epoxy based, and silicone based, etc.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in side chain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used. These film has small retardation and small photoelasticity coefficient, therefore can solve a problem such as polarizing variation caused by distortion of the polarizing plate, and excellent in humidication durability because of those small moisuture permeability.

In general, a thickness of the protection film, which can be determined arbitrarily, is 1 to 500 μm, preferably 1 to 300 μm, and especially preferably 5 to 200 μm in viewpoint of strength, work handling and thin layer.

Moreover, it is preferable that the protective film may have as little coloring as possible. Accordingly, a protective film having a retardation value in a film thickness direction represented by Rth=[(nx+ny)/2−nz]×d of −90 nm to +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protective film may mostly be cancelled using a protective film having a retardation value (Rth) of −90 nm to +75 nm in a thickness direction. The retardation value (Rth) in a thickness direction is preferably −80 nm to +60 nm, and especially preferably −70 nm to +45 nm.

As a protective film, if polarization property and durability are taken into consideration, cellulose based polymer, such as triacetyl cellulose, is preferable, and especially triacetyl cellulose film is suitable. On the other hand, the protective film of triacetyl cellulose has a large retardation value Rth in the direction of the thickness, causing a problem with coloring, and the resin compositions that contain alternate copolymer made of isobutylene and N-methyl maleimide, and copolymer of acrylonitrile and styrene, which have a retardation value Rth of 30 nm or less, can be utilized, almost solving coloring. In addition, when the protective films are provided on both sides of the polarizer, the protective films comprising same polymer material may be used on both of a front side and a back side, and the protective films comprising different polymer materials etc. may be used.

A hard coat layer may be prepared, or antireflection processing, processing aiming at sticking prevention, diffusion or anti glare may be performed onto the face on which the polarizing film of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the transparent protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer used for other members.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight part to the transparent resin 100 weight part that forms the fine concavo-convex structure on the surface, and preferably 5 to 25 weight part. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

Adhesives are used for adhesion processing of the above described polarizer and the transparent protective film. As adhesives, isocyanate derived adhesives, polyvinyl alcohol derived adhesives, gelatin derived adhesives, vinyl polymers derived latex type, aqueous polyurethane based adhesives, aqueous polyesters derived adhesives, etc. may be mentioned. The adhesives are usually aqueous solution.

A polarizing plate is manufactured by adhering the above described transparent protective film and the polarizer using the above described adhesives. The application of adhesives may be performed to any of the transparent protective film or the polarizer, and may be performed to both of them. After adhered, drying process is given and the adhesion layer comprising applied dry layer is formed. Adhering process of the polarizing film and the transparent protective film may be performed using a roll laminator etc. Although a thickness of the adhesion layer is not especially limited, it is usually approximately from 0.1 to 5 μm.

An optical member disposed on both sides of the liquid crystal cell comprises at least the polarizing plate. And the optical member, described above, comprises the retardation plate or the laminated retardation plate. The polarizing plate may be used laminating with other optical layers in practice. The optical layers, which may be used for formation of a liquid crystal display etc., such as a reflector, a transflective plate, and a viewing angle compensation film, may be used with especially no limitation. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal biaxial stretching and a bi-directional stretched film as inclined orientation film etc. may be used. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transflective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised.

Proper adhesion means, such as an adhesive layer, may be used for laminating. On the occasion of adhesion of the above described polarizing plate and other optical films, the optical axis may be set as a suitable configuration angle according to the target retardation characteristics etc.

A pressure sensitive adhesive layer may be formed on the optical member, which comprises at least one layer of the above described laminated retardation plate or polarization plate with retardation plate, to attached on other optical films, such as liquid crystal cells, etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Adhesive layers can be provided to one side or both sides of the optical member which comprises at least one layer of a laminated retardation plate or a polarizing plate with retardation plate, as described above, in accordance with an appropriate method. As examples, a method where an adhesive solution of approximately 10% to 40% by weight, where a base polymer or compositions thereof are solved or dispersed in a solvent made of an appropriate single solvent, such as toluene or ether acetate, or a mixture of these, is prepared, and this is directly provided onto a polarizing plate or an optical member in accordance with an appropriate developing method, such as a flowing and expanding method or an application method, or a method where an adhesive layer is formed on a separator in a similar manner as in the above, and this is transferred onto an optical member, can be cited.

Adhesive layers can be provided to one side or both sides of the optical member, in the form of multiple layers of different compositions or different types. In addition, in the case where they are provided on both sides, adhesive layers of different compositions, different types or different thicknesses can be provided on the front and rear surfaces of the polarizing plate or the optical member. The thicknesses of the adhesive layers can be appropriately determined on the basis of the purpose of utilization or adhesiveness, and are, in general, in a range of from 1 μm to 500 μm, preferably in a range of from 5 μm to 200 μm, and more preferably, in a range of from 10 μm to 100 μm.

A separator is temporarily made to adhere to the exposed surface of an adhesive layer, so that the exposed surface is covered for the purpose of preventing staining and the like, until it is used. As a result of this, the adhesive layer can be prevented from being touched when it is generally handled. Appropriate thin sheets, such as plastic films, rubber sheets, paper, cloth, unwoven cloth, nets, foaming sheets, metal foils and laminated bodies of these, can be used as a separator, without having the thickness conditions as described above, after being treated in a conventional manner, for example, coating processed with an appropriate peeling agent, such as a silicone based, long-chain alkyl based or fluorine based substance, or molybdenum sulfide, if necessary.

In addition, in the present invention, ultraviolet absorbing property may be given to the above-mentioned each layer, such as the optical member, an adhesive layer, using a method of adding UV absorbents, such as salicylic acid ester type compounds, benzophenol type compounds, benzotriazol type compounds, cyano acrylate type compounds, and nickel complex salt type compounds.

The liquid crystal display is applicable to a various kind of devices that have conventionally been known. The form of the liquid crystal display can be determined in accordance with the prior art. The liquid crystal display generally comprises a liquid crystal cell, optical members as described above disposed on both sides of the liquid crystal cell, and a backlight. The liquid crystal display is formed by assembling the above described components in an appropriate manner with a driving circuit incorporated therein. An arbitrary type of liquid crystal cell, such as a twisted nematic type, super twisted nematic type or n type, may be used in the liquid crystal display according to the present invention. Here, the optical members that include a polarizing plate, and which are disposed on both sides of the liquid crystal cell may be of the same type or of different types.

A behind-the-screen type backlight, a side light type backlight, or a light source in plain form can be used as the backlight. In addition, a reflection plate can be used for the backlight. Furthermore, one or more layers of appropriate parts, such as a diffusion plate, an anti-glare layer, an anti-reflection film, a protective plate, a prism array, a lens array sheath and a light diffusing plate, can be appropriately disposed in appropriate positions at the time of the formation of the liquid crystal display.

Subsequently, organic electro luminescence equipment (organic EL display) will be explained. Generally, in organic EL display, a transparent electrode, an organic emitting layer, and a metal electrode are laminated on a transparent substrate in an order configuring an illuminant (organic electro luminescence illuminant). Here, an organic emitting layer is a laminated material of various organic thin films, and much compositions with various combination are known, for example, a laminated material of hole injection layer comprising triphenylamine derivatives etc., an emitting layer comprising fluorescent organic solids, such as anthracene; a laminated material of electronic injection layer comprising such an emitting layer and perylene derivatives, etc.; laminated material of these hole injection layers, emitting layer, and electronic injection layer etc.

An organic EL display emits light based on a principle that positive hole and electron are injected into an organic emitting layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic emitting layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, a very thin film about 10 nm forms an organic emitting layer in thickness. For this reason, light is transmitted nearly completely through organic emitting layer as through transparent electrode. Consequently, since the light that enters, when light is not emitted, as incident light from a surface of a transparent substrate and is transmitted through a transparent electrode and an organic emitting layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic emitting layer that emits light by impression of voltage, and at the same time equipped with a metal electrode on a back side of organic emitting layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

In the following, the present invention is described by citing Examples and the like, but the present invention is not limited to these Examples.

(Dimensional Change Rate)

The shrinking and expansion of the stretched films was measured using a thermo mechanical analyzer (TMA) manufactured by Rigaku Corporation. The pieces of samples in cylinder form having the dimensions: width 15 mm×length 10 mm were measured. The measurement was carried out relative to a reference of length (Lo) in the length of the slow axis and in the length of the fast axis of a stretched film at 25° C., and the dimensional change rate was calculated at each degree as the temperature was changed by 1° C. per minute or −1° C. per minute. The difference between the measured length and the reference length (Lo) is the amount of change (ΔL), and the dimensional change rate is ΔL/Lo.

Table 1 shows the dimensional change rate of the measured samples (retardation plates). In the case where the temperature exceeded 25° C., the samples expanded to have positive values, and in the case where temperature was lower than 25° C., the samples shrunk to have negative values. The relationship between the dimensional change rates in the direction of the slow axis and in the direction of the fast axis, which is expressed |X1|>|X2|, and |Y1|<|Y2|, indicates the relationship of the absolute values between the respective dimensional change rates.

A retardation plate of which the dimensional change rates have the relationship |X1|>|X2|, that is to say, a PF film (made of polycarbonate), manufactured by Kaneka Corporation, was stretched (front retardation Δnd=85 nm) to be used. This is Sample 11. Table 1 shows the dimensional change rates in the direction of the slow axis and in the direction of the fast axis at each degree.

Retardation plates of which the dimensional change rates have the relationship |Y1|<|Y2|, that is to say, an ARTON film, manufactured by JSR Corporation, was stretched (front retardation Δnd=80 nm), and a ZEONOR film, manufactured by Nippon Zeon Co., Ltd., was stretched (front retardation Δnd=85 nm) to be used. These are Samples 21 and 22, in this order. Table 1 shows the dimensional change rates in the direction of the slow axis and in the direction of the fast axis at each degree.

TABLE 1

| | Sample 11: \|X1\| > \|X2\| | | Sample 21: \|Y1\| < \|Y2\| | | Sample 22: \|Y1\| < \|Y2\| | |
|---|---|---|---|---|---|---|
| | (PF film) | | (ARTON film) | | (ZEONOR film) | |
| | Dimensional change rate | | Dimensional change rate | | Dimensional change rate | |
| Temperature | (ΔL/Lo/10⁻⁴) | | (ΔL/Lo/10⁻⁴) | | (Δ/Lo/10⁻⁴) | |
| (° C.) | X1 | X2 | Y1 | Y2 | Y1 | Y2 |
| 50 | 16.8 | 15.5 | 14.7 | 18.5 | 14.O | 17.7 |
| 40 | 9.4 | 9.0 | 8.6 | 11.0 | 8.1 | 10.6 |
| 30 | 2.9 | 2.8 | 2.6 | 4.3 | 2.4 | 4.0 |
| 25 | 0.0 | 0.0 | 0.0 | 0.0 | 0.0 | 0.0 |
| 20 | −3.2 | −2.8 | −2.9 | −3.1 | −2.8 | −2.9 |
| 10 | −9.2 | −8.4 | −8.5 | −9.4 | −8.5 | −9.0 |
| 0 | −15.2 | −14.0 | −14.5 | −15.9 | −14.1 | −15.0 |
| −10 | −21.5 | −19.9 | −20.4 | −22.0 | −19.9 | −21.1 |
| −20 | −26.9 | −25.2 | −25.9 | −28.2 | −25.0 | −27.0 |

### Comparison Example 1

Two retardation plates (Sample 11) were made to adhere to a glass plate (manufactured by Matsunami Glass Ind., Ltd., product number: 5, size: 1.3 mm×65 mm×165 mm) using an adhesive. At the time of the adhesion, the glass plate and the retardation plates were arranged in a manner where the slow axes of the retardation plates become parallel to each other, and the longitudinal direction of the glass plate and the slow axes of the retardation plates become parallel to each other, and thus, a laminated retardation plate was fabricated.

### Comparison Example 2

A laminated retardation plate was fabricated in the same manner as in Comparison Example 1, except that two retardation plates (Sample 21) were used instead of the two retardation plates (Sample 11) used in Comparison Example 1.

### Example 1

A laminated retardation plate was fabricated in the same manner as in Comparison Example 1, except that two retardation plates (Sample 11 and Sample 21) were used, in this order, instead of the two retardation plates (Sample 11) used in Comparison Example 1.

### Example 1

A laminated retardation plate was fabricated in the same manner as in Comparison Example 1, except that two retardation plates (Sample 11 and Sample 22) were used, in this order, instead of the two retardation plates (Sample 11) used in Comparison Example 1.

The change in the front retardation value Δnd in a range from −20° C. to 30° C. of laminated retardation plates adhering to a glass plate which were obtained in the Comparison Examples and in the Examples was measured using a RETS-1100, manufactured by Otsuka Electronics Co., Ltd. The change in the front retardation value Δnd was read out from the RETS-1100, manufactured by Otsuka Electronics Co., Ltd., after the laminated retardation plates adhering to a glass plate were cooled by being soaked in liquid nitrogen, taken out to an atmosphere at room temperature, and then, the frost adhering to the glass wiped away with ethanol.

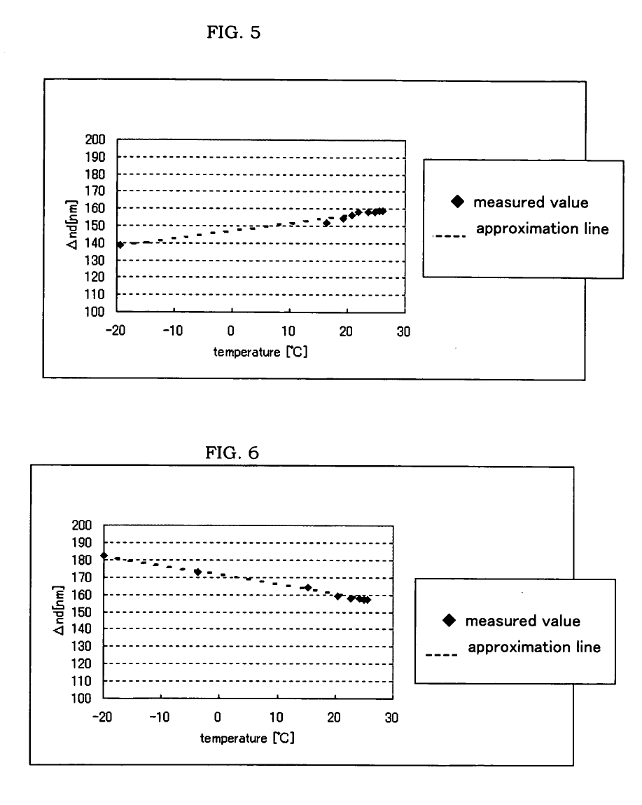

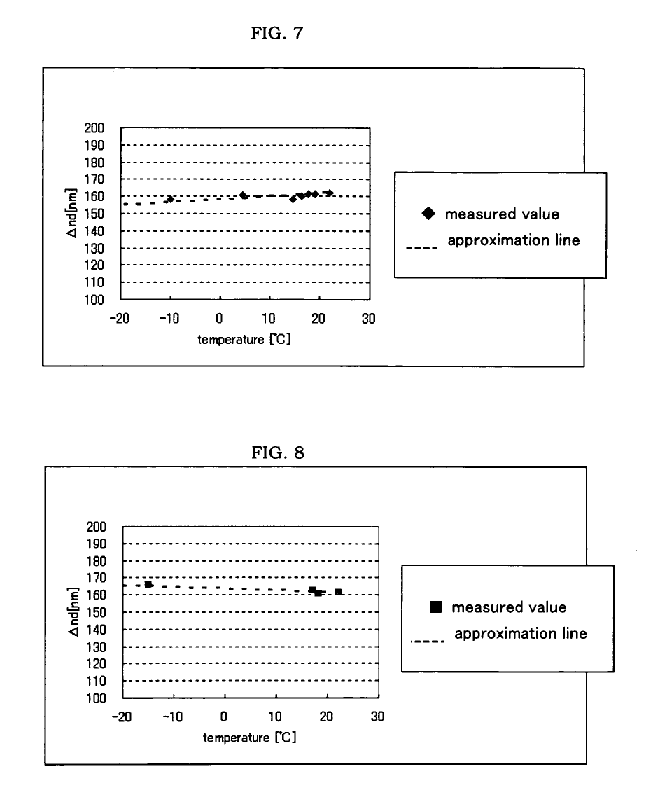

FIG. 5 shows the relationship between the temperature and the change in the front retardation value Δnd in Comparison Example 1, FIG. 6 shows the relationship between the temperature and the change in the front retardation value Δnd in Comparison Example 2, FIG. 7 shows the relationship between the temperature and the change in the front retardation value Δnd in Example 1, and FIG. 8 shows the relationship between the temperature and the change in the front retardation value Δnd in Example 2. It is recognized that the change in the retardation value as the temperature changes is small in the Examples, in comparison with the comparison examples. Here, in FIGS. 5 to 8 ♦ and ▪ shows measured values, and . . . shows approximation lines tracing the measured values.

1. A laminated retardation plate comprising at least two retardation plates made of stretched films of a thermoplastic resin, wherein
under the same temperature condition,
at least one retardation plate have the relationship of |X1|>|X2|, where X1 represents the dimensional change rate in the direction of slow axis and X2 represents the dimensional change rate in the direction of fast axis;
at least one retardation plate have the relationship of |Y1|<|Y2|, where Y1 represents the dimensional change rate in the direction of slow axis and Y2 represents the dimensional change rate in the direction of fast axis; and
the each retardation plate is arranged so as to the direction of slow axes thereof are in the same directions.

2. A polarizing plate with retardation plate, comprising the laminated retardation plate according to claim 1 and a polarizing plate.

3. An image display, comprising the laminated retardation plate according to claim 1.

4. A liquid crystal display comprising a liquid crystal cell and an optical member containing a polarizing plate disposed on both sides of the liquid crystal cell, wherein
the optical member at least on one side of the liquid crystal cell has the polarizing plate with retardation plate according to claim 2.

5. The liquid crystal display according to claim 4, wherein the slow axes of the retardation plates of said polarizing plate with retardation plate are disposed so as to be parallel to or perpendicular to the longitudinal direction of the liquid crystal display.

6. A liquid crystal display comprising a liquid crystal cell and an optical member containing a retardation plate made of stretched films of a thermoplastic resin and a polarizing plate disposed on both sides of the liquid crystal cell, wherein
under the same temperature conditions,
at least one retardation plate in the optical member disposed on one side have the relationship of |X1|>|X2|, where X1 represents the dimensional change rate in the direction of slow axis and X2 represents the dimensional change rate in the direction of fast axis;
at least one retardation plate in the optical member disposed on the other side have the relationship of |Y1|<|Y2|, where Y1 represents the dimensional change rate in the direction of slow axis and Y2 represents the dimensional change rate in the direction of fast axis; and
the optical members disposed on both sides of the liquid crystal cell are arranged so as to the direction of slow axes of the each retardation plate in said optical members is in the same directions.

7. The liquid crystal display according to claim 6, wherein the slow axes of the retardation plates of said retardation plate are disposed so as to be parallel to or perpendicular to the longitudinal direction of the liquid crystal display.

8. An image display, comprising the polarizing plate with retardation plate according to claim 2.
